(19) United States
(12) Patent Application Publication
(10) Pub. No.: US 2019/0385156 A1
(43) Pub. Date: Dec. 19, 2019

(54) Decentralized Crypto Token Swap Platform on Mobile Device Apps

(71) Applicant: Bing Liu, Rolling Hill, CA (US)

(72) Inventor: Bing Liu, Rolling Hill, CA (US)

(21) Appl. No.: 16/397,319

(22) Filed: Apr. 29, 2019

Related U.S. Application Data
(60) Provisional application No. 62/663,658, filed on Apr. 27, 2018.

(51) Int. Cl. G06Q 20/36; G06Q 20/06; G06Q 20/32; G06Q 20/38; H04L 9/06

(52) U.S. Cl. CPC G06Q 20/3678; G06Q 20/0658; H04L 9/0637; G06Q 20/3676; G06Q 20/381; G06Q 20/3223

(57) ABSTRACT

A decentralized crypto token swap platform available through multiple mobile device applications, or apps. The platform supports same-blockchain and cross-blockchain trading of multiple crypto tokens, including cryptocurrency and non-fungible crypto tokens.

### PRIORITY

This applications claims the benefit of U.S. Provisional 62/663,658, filed Apr. 27, 2018, which is hereby incorporated by reference as if submitted in its entirety.

### FIELD OF THE INVENTION

The present invention relates to decentralized digital asset management, and, more particularly, a decentralized digital asset swap platform.

### BACKGROUND

With the advance of technology and spread of Internet access, the world is becoming more connected and people have access to nearly any information they seek. The number of internet users has been growing exponentially. Today, over 3.8 billion people has internet access, which is over 50% of the world's population, and this number is expected to rise. Over the past 20 years, the creation and usage of websites has been expanding with widespread access to the internet. The number of websites totaled 1 million in 1997, then reached and maintained at a milestone of 1 billion since 2016.

Another growing trend in the digital world is the development of decentralized trust. Utilizing blockchain technology, payments and/or contracts may be performed by distributed consensus and recorded on a blockchain. A blockchain is simply a distributed ledger of all transactions with respect to payments and/or established contracts. Digital coins, such as Bitcoin (BTC) or Ether (ETH), are much more than a digital currency, but a network of trust that provides the basis for so much more than just currencies. Cryptocurrency, such as BTC or ETH, is a collection of concepts and technologies that form the basis of a digital money ecosystem. Units of currency, such as BTC or ETH, are used to store and transmit value among users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake).

The crypto token market has reached a market cap of nearly $840 billion USD in early 2018, with over $22 billion daily trading volume. There are nearly 1,600 cryptocurrencies and numerous other crypto tokens such as non fungible crypto tokens. These crypto tokens are mainly being traded on centralized exchanges which are frequently hacked, and the non fungible crypto tokens are being traded on their own websites. The market lacks a decentralized crypto token exchange platform that is safe, transparent, and supports the trading of multiple crypto token types, including cross-blockchain crypto token trading.

There are currently many problems with the existing crypto token trading platforms. Most cryptocurrencies are being traded on centralized exchanges that requires users to register an account and transfer their crypto tokens to the exchange. These exchanges mainly have the following issues:
Safety: These centralized exchanges store the private key to the wallet addresses associated with users' accounts. This raises users' risks of losing their crypto tokens when the exchange platforms are hacked and the private keys are stolen.
Liquidity: When users want to trade their crypto tokens, they need to first transfer the crypto tokens to the wallet address provided on the exchange platform. If they later need the crypto tokens for other uses, they would need to first transfer the crypto tokens out of the exchange.
Fee: In addition to the gas fee of crypto token transactions, centralized exchanges also charges a trading fee that can go up to over 10%.
Transparency: The fact that these exchange platforms are centralized makes them less reliable as the crypto token trading process is not transparent.
P2P: Centralized exchanges are not truly peer-to-peer as the exchange platform acts as a middleman who escrows the crypto tokens stored on the platform.

Another gap in the current crypto token trading market is the lack of exchange options between cryptocurrencies and other types of crypto tokens such as non fungible crypto tokens. For instance, non-fungible crypto tokens released on the Ethereum network normally follow the ERC721 standard. These non-fungible crypto tokens are exchangeable with Bill, but cannot be traded with any other crypto tokens, no matter if they are also launched on the Ethereum network or on other blockchains.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is an overview diagram of a decentralized crypto token swap platform in accordance with at least one embodiment of the disclosed invention;

FIG. 2 is an overview diagram of a same-chain crypto token swap process in accordance with at least one embodiment of the disclosed invention;

FIG. 3 is an overview diagram of a cross-chain crypto token swap process in accordance with at least one embodiment of the disclosed invention; and

FIG. 4 illustrates a simplified functional block diagram of a computer system 700.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

In order to solve the above problems of the crypto token trading market, the disclosed invention provides a decentralized crypto token swap platform that will be available through multiple mobile device applications, or apps. The platform supports same-blockchain and cross-blockchain trading of multiple crypto tokens, including cryptocurrency and non-fungible crypto tokens. This platform achieves the following improvements:
Safety: The platform does not store any of the users' private keys and users remain full custodian of their crypto tokens. This makes the platform less susceptible to attacks and hacks and enhances the safety of users' crypto tokens. The platform has no direct access to users' wallets, thus all transactions are sure to be approved by the crypto token owner.
Liquidity: Since the platform does not require users to transfer their crypto tokens to the platform, users get more freedom and liquidity as they can freely send the crypto tokens around without having to transfer the crypto tokens out of the platform.
Fee: As a decentralized platform, it can reduce charged fees through the removal of third-party authenticator and other costs.
Transparency: All transactions of the platform are triggered by smart contracts or protocol implementations, and are fully traceable on the blockchain. The platform provides trust-less authentication and authorization of crypto token transactions,
P2P: The platform is truly peer-to-peer as users are directly communicating and exchanging crypto tokens, straight through their crypto wallets.

### Platform Overview

The decentralized crypto token swap platform utilizes smart contracts and protocol implementations to support the peer-to-peer trading of crypto tokens based on different blockchains and different standards.

The platform is designed for both same-chain and cross-chain crypto token trading, with an OrderBook that can be stored both in the cloud or on a public blockchain. The platform will be run on mobile device Apps, through which users can query available orders from the OrderBook and call functions from respective smart contracts to process crypto tokens trading. Users of the Apps will be able to interact directly and can settle the exchange of crypto tokens automatically via smart contracts and the Settle Controller which authenticates and ensures the safe exchange of crypto tokens that are being traded between two users.

For cross-chain crypto token trading, all processes are the same with same-chain crypto token trading except for the Settle Controller section. The Settle Controller will require one extra step to protect the fairness of the cross-chain crypto token swap process.

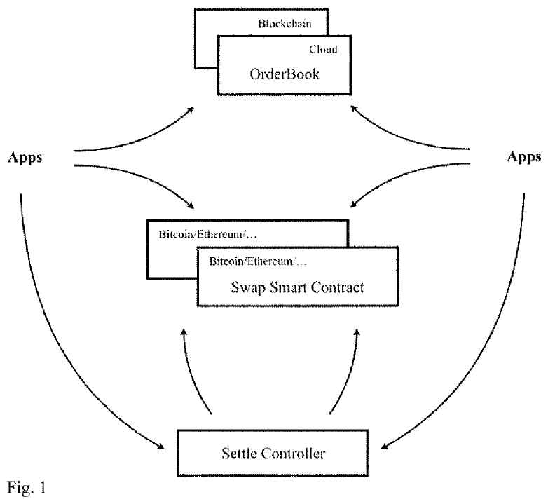

FIG. 1 is a generic graphical display of the decentralized crypto token swap platform.

### Case 1: Same-Blockchain (Ex. Ethereum)

For same-blockchain crypto token trading, the decentralized crypto token swap platform supports the exchange of all types of crypto tokens released on that blockchain. Take Ethereum as an example, the platform can facilitate the swap of ETH, ERC20 crypto tokens, and even ERC721 non fungible crypto tokens through the Ethereum Swap Smart Contract.

Step 1). Assume an User A possesses 1 ERC721 token and would like to exchange it for 0.5 ETH, he/she would create a request order and publish it to the OrderBook.

Step 2). User B queries open orders from the OrderBook and sees User A's request order.

Step 3). User B takes User A's order and calls the Approve function from the Ethereum Swap Smart Contract. This will approve 0.5 ETH of User B's wallet to the Swap Smart Contract with signature from User A's request order. Once this function is successfully called, User A will be informed through direct messaging.

Step 4). User A can manually approve the ERC721 token to the Ethereum Swap Smart Contract or set up auto approval when will call the Approve function automatically when someone takes the request and approves.

Step 5). Once the Approve function is completed, User A will notify the Settle Controller.

Step 6). The Settle Controller then will transfer the exchanged crypto tokens through the Settle function of the Swap Smart Contract. It will decode approval data based on request order data and it authenticated, User A's collectible will be sent to User B and User B's 0.5 ETH will be transferred to User A through the smart contract.

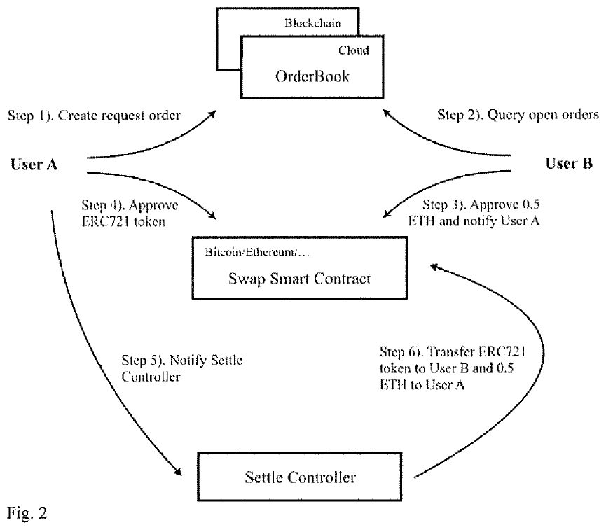

FIG. 2 is a graphical display of the same-chain crypto token swap process.

Summary of the basic major functions of swap smart contract for each blockchain:
Approve=>input parameters include the Swap Smart Contract's contract address and crypto token approval value

This function gives the Swap Smart Contract access to the crypto token to be traded
Settle=>input parameters include User A and User B's wallet addresses, crypto token amounts, crypto token contract addresses, expiration time, nonce number, and signatures

The Settle Controller will use the expiration time, nonce number and the signatures to validate the swap. If the swap is validated, the crypto tokens being exchanged will be transferred to the other party.

### Case 2: Cross-Blockchain (Ex. Ethereum and Bitcoin)

For cross-blockchain crypto token trading, the decentralized crypto token swap platform supports the exchange of crypto tokens released on different blockchains though blockchain-specific Swap Smart Contracts. Take Ethereum and Bitcoin as an example, the platform can facilitate the swap of ETH and BTC.

Step 1). Assume an User A possesses 10 ETH and would like to exchange it for 0.6 BTC, he/she would create a request order and publish it to the OrderBook.

Step 2). User B queries open orders from the OrderBook and sees User A's request order.

Step 3). User B takes User A's order and calls the Approve function from the Bitcoin Swap Smart Contract. This will approve 0.6 BTC of User B's wallet to the Bitcoin Swap Smart Contract with signature from User A's request. Once this function is successfully called, User A will be informed through direct messaging.

Step 4). User A can manually approve the 10 ETH to the Ethereum Swap Smart Contract or set up auto approval when will call the Approve function automatically when someone takes the request and approves.

Step 5). Once the Approve function is successfully called, User A will transfer the 10 ETH to the Settle Controller.

Step 6). User B then transfers the 0.6 BTC to the Settle Controller,

Step 7). The Settle Controller will call the Deliver function from the Ethereum Swap Smart Contract and the Bitcoin Swap Smart Contract. The Deliver functions will send User A's 10 ETH to User B and User B's 0.6 BTC to User A through the smart contracts.

Note: If User B does not transfer the 0.6 BTC or either of the Deliver function fails or the expiration time arrives, the Settle Controller will do DeliverBack to transfer the 10 ETH back to User A and the 0.6 BTC back to User B.

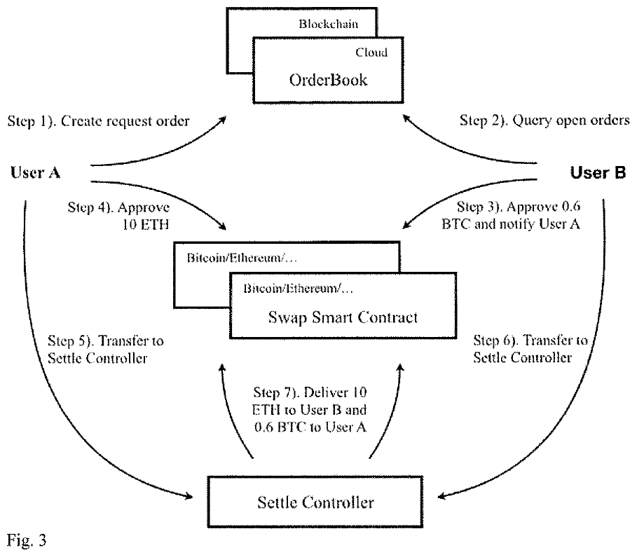

FIG. 3 is a graphical display of the cross-chain crypto token swap process.

Summary of the other major functions of Swap Smart Contract for each blockchain:
Transfer=>input parameters include target address and crypto token transfer value This function transfers the crypto token to be traded to the Swap Smart Contract.
Deliver=>input parameters include User's wallet address, crypto token amount, crypto token contract address, nonce number, and signatures

If both users transfer their crypto token to be traded to the Settle Controller with expiration time, and all data are validated with signatures, the Settle Controller will call the Deliver function to send the crypto tokens being exchanged will be transferred to the other party.
DeliverBack=>input parameters include crypto token's original owner's wallet address, crypto token amount, crtypto token contract address, nonce number, and signatures

If either user does not transfer the crypto token, or either of the Deliver function fails, or the expiration time arrives, the Settle Controller will call the DeliverBack function to return the crypto tokens being exchanged back to their original owners.

### Key Features of the Decentralized Crypto Token Swap Platform

The decentralized crypto token swap platform described above has five key features:

Transparent OrderBook:

The OrderBook that contains all the crypto token swap request order information will be available to the public through open, transparent storage. The OrderBook can use a cloud-based storage, or be placed on a public blockchain.

Automatic order matching:

The platform will automatically match orders that are swapping the same kinds of crypto tokens.

Optional cross-chain partial swap (order split):

For cross-chain crypto token swap, if the user allows partial swap, the order request will be split into multiple smaller order requests each at $100 crypto token value. This provides cross-chain crypto token swap participants extra level of security and efficiency.

App-based:

The platform is run through Apps, and the OrderBook will be accessible to the users of these Apps via their mobile devices.

Variable transaction fee:

The platform has a SetPolicy function which can be used to adjust and customize the transaction fee for different crypto tokens when needed.

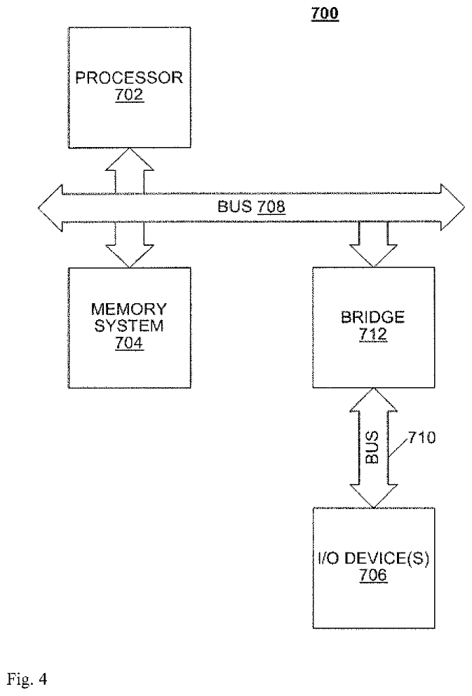

FIG. 4 is an example of a simplified functional block diagram of a computer system 700. The functional descriptions of the present invention can be implemented in hardware, software or some combination thereof.

As shown in FIG. 4, the computer system 700 includes a processor 702, a memory system 704 and one or more input/output (I/O) devices 706 in communication by a communication ‘fabric’. The communication fabric can be implemented in a variety of ways and may include one or more computer buses 708, 710 and/or bridge and/or router devices 712 as shown in FIG. 4. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that exemplary computing system 700 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I claim:

1. A method for swapping cryptocurrency tokens cross-chain, the method, with at least one computing device, comprising:
creating, by a first computer user, a request order specifying an amount of a first type of cryptocurrency token;
selecting an open order of a plurality of open orders, the open order specifying an amount of a second type of cryptocurrency token and associated with a second computer user;
approving the amount of the second type of cryptocurrency token set forth by the selected open order;
approving the amount of the first type of cryptocurrency token set forth by the request order;
transferring the approved amount of the first type of cryptocurrency token to a settle controller from the first computer user;
transferring the approved amount of the second type of cryptocurrency token to the settle controller from the second computer user;
delivering, by the settle controller, the amount of the first type of cryptocurrency token to the second computer user; and
delivering, by the settle controller, the amount of the second type of cryptocurrency token to the first computer user.

2. The method of claim 1, wherein approving the amount of the second type of cryptocurrency token further comprises:
in response to approval, notifying the first computer user of the amount of the second type of cryptocurrency token's approval.
